(19) United States
(12) Patent Application Publication
(10) Pub. No.: US 2026/0006339 A1
(43) Pub. Date: Jan. 1, 2026

(54) LOCKER SYSTEM AND LOCKER MANAGEMENT METHOD

(71) Applicant: PixArt Imaging Inc., Hsin-Chu City (TW)

(72) Inventors: Chih-Huan Wu, Hsin-Chu City (TW); Wen-Yen Su, Hsin-Chu City (TW); Hsin-Hsiang Lo, Hsin-Chu City (TW); Yu-Hsiang Huang, Hsin-Chu City (TW)

(73) Assignee: PixArt Imaging Inc., Hsin-Chu City (TW)

(21) Appl. No.: 19/214,020

(22) Filed: May 20, 2025

Related U.S. Application Data
(60) Provisional application No. 63/664,201, filed on Jun. 26, 2024.

(51) Int. Cl. H04N 23/74; A47G 29/14; H04N 23/71

(52) U.S. Cl. CPC H04N 23/74; A47G 29/14; H04N 23/71

(57) ABSTRACT

A locker system, comprising: a locker; a first light source, located inside the locker; an optical sensor, located inside the locker, configured to sense optical data; and a processing circuit, configured to determine a light source condition of the first light source or a locker condition of the locker according to the optical data. By such system, the light source condition and the locker condition may be automatically checked according to the optical data sensed by the optical sensor in the locker, rather than manually checked one by one. Besides, the parameters of the components in the locker can be automatically set according to the optical data sensed by the optical sensor in the locker, rather than manually checked one by one.

### CROSS REFERENCE TO RELATED APPLICATIONS

This application claims the benefit of U.S. Provisional Application No. 63/664,201, filed on Jun. 26, 2024. The content of the application is incorporated herein by reference.

### BACKGROUND OF THE INVENTION

### 1. Field of the Invention

The present invention relates to a locker system and a locker management method, and particularly relates to a locker system and a locker management method which can automatically determine a light source condition of a light source or a locker condition of a locker.

### 2. Description of the Prior Art

In modern society, online shopping is becoming more and more popular, and correspondingly, a self-service pickup system is becoming more and more popular. The self-service pickup system allows users to get their purchased items by themselves without the assistance of a store staff. Self-service pickup systems usually require a large number of lockers of different sizes, and these lockers also need to have a determining system that can determine whether there are goods placed in them or whether the goods have been taken out.

However, different parameters need to be set for the determining system of lockers of different sizes. In prior art, the setting is performed manually one by one, which is quite time-consuming. Moreover, after the self-service pickup system has been used for a long time, the locker itself may be damaged or the device in its determining system may be damaged, which will affect the determination of the determining system. In the prior art, these damages are also manually inspected and repaired one by one, which is also quite time-consuming. Therefore, a new mechanism is needed to improve the above issues.

### SUMMARY OF THE INVENTION

One objective of the present invention is to provide a locker system which can automatically determine a condition related with the locker, or automatically set parameters of the components inside the locker system.

Another objective of the present invention is to provide a locker management which can automatically determine a condition related with the locker, or automatically set parameters of the components inside the locker system.

One embodiment of the present invention provides a locker system, comprising: a locker; a first light source, located inside the locker; an optical sensor, located inside the locker, configured to sense optical data; and a processing circuit, configured to determine a light source condition of the first light source or a locker condition of the locker according to the optical data.

Another embodiment of the present invention provides a locker management method, applied to a locker comprising a first light source and an optical sensor provided therein, comprising: (a) the optical sensor sensing optical data; and (b) determining a light source condition of the first light source or a locker condition of the locker according to the optical data.

In view of above-mentioned embodiments, the light source condition and the locker condition may be automatically checked according to the optical data sensed by the optical sensor in the locker, rather than manually checked one by one. Besides, the parameters of the components in the locker can be automatically set according to the optical data sensed by the optical sensor in the locker, rather than manually checked one by one.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram illustrating a locker system according to one embodiment of the present invention.

FIG. 1B is a schematic diagram illustrating a combination module, according to one embodiment of the present invention.

FIG. 1C is a schematic diagram illustrating a location of the combination module, according to one embodiment of the present invention.

FIG. 1D is a schematic diagram illustrating a mounting angle of the combination module shown in FIG. 1C, according to one embodiment of the present invention.

FIG. 2 is a schematic diagram illustrating lockers of different sizes according to embodiments of the present invention.

FIG. 3 and FIG. 4 are schematic diagrams illustrating examples of determining lockers of different sizes, according to embodiments of the present invention.

FIG. 5 is a schematic diagram illustrating examples of determining the light source condition or the locker condition, according to embodiments of the present invention.

FIG. 6 is a schematic diagram illustrating an example of defining a background region, according to embodiments of the present invention.

FIG. 7 is a schematic diagram illustrating avoiding camouflage of an object, according to one embodiment of the present invention.

FIG. 8 is a schematic diagram illustrating a locker management method, according to one embodiment of the present invention.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

Additionally, in following embodiments, the optical data may mean images, and the object may be any type of object, such as goods, packages. Furthermore, the lockers described below are not limited to be applied to a self-service pickup system. For example, the lockers stated below may be applied to a luggage storage system.

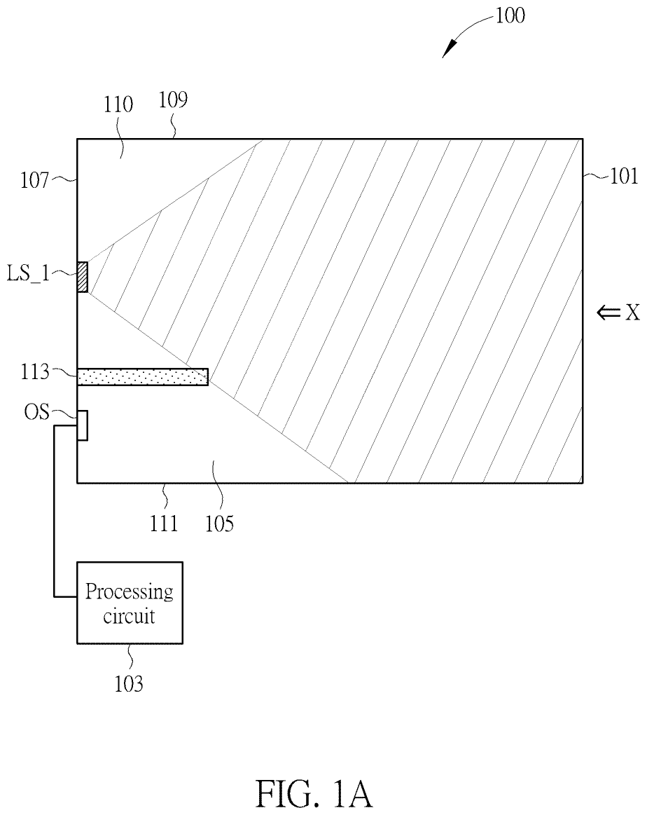

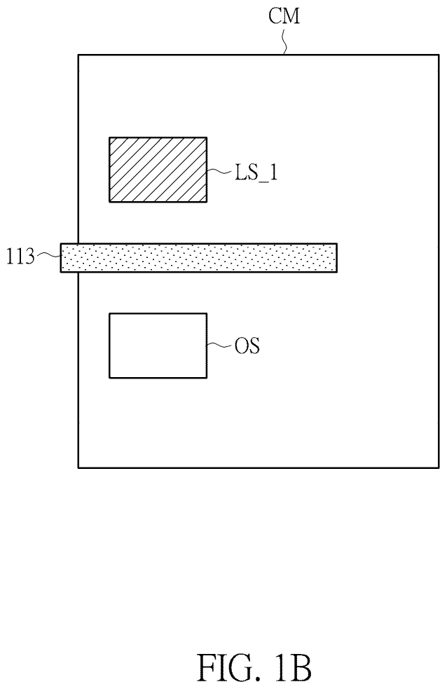

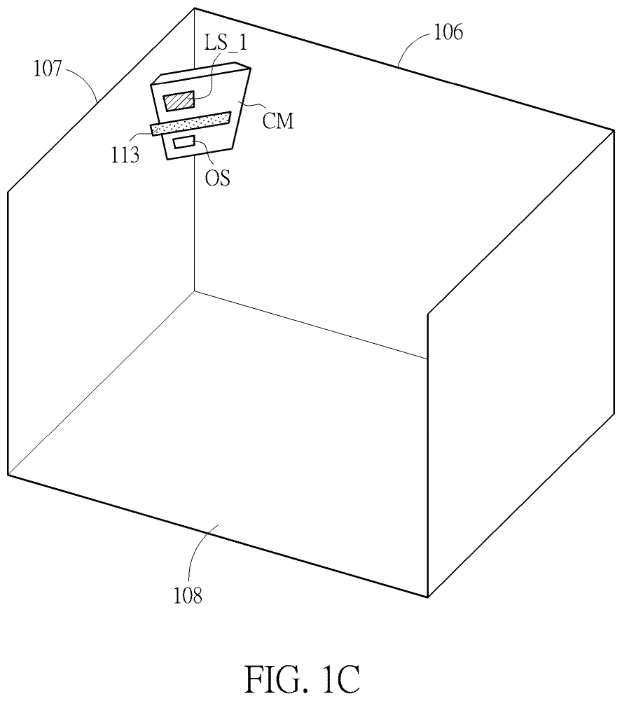

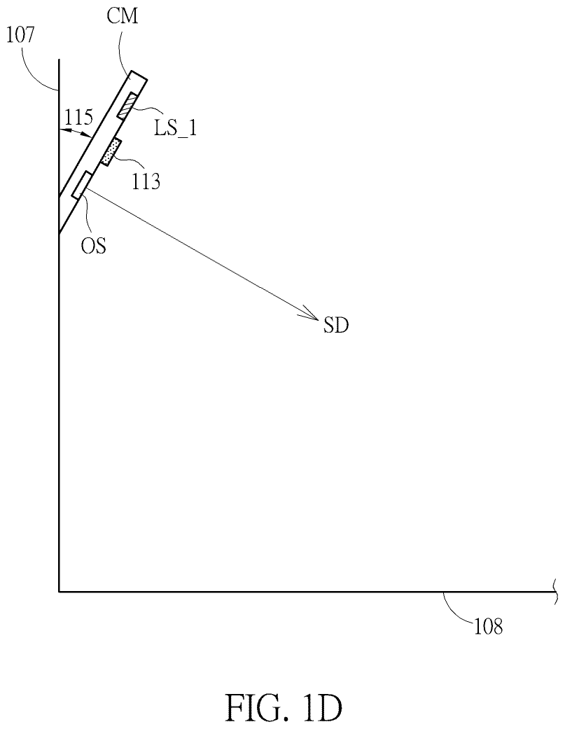

FIG. 1A is a schematic diagram illustrating a locker system 100 according to one embodiment of the present invention. As shown in FIG. 1A, the locker system 100 comprises a locker 101, a processing circuit 103, a first light source LS_1 and an optical sensor OS. The locker system 100 may comprise more than one locker which has components the same as which inside the locker 101, but only one locker 101 is used as an example for explaining. The processing circuit 103 may be a circuit which has computation abilities, such as a micro controller or a CPU. The processing circuit 103 may be provided at any location. For example, the processing circuit 103 may be provided in one of the lockers or be provided in a computer which is used to control the whole locker system 100. In one embodiment, the processing circuit 103 may be incorporated into a CPU which is used to control the whole locker system 100.

The first light source LS_1 is located inside the locker 101 and emits first light to an inner space 105 of the locker 101. In the embodiment of FIG. 1A, the first light source LS_1 is located on a side surface 107 of the locker 101. However, the first light source LS_1 may be provided at any required location of the locker 100. For example, the first light source LS_1 may be provided at a top surface 109 of the locker 101 or at a corner 110 of the locker 101. The optical sensor OS is also located inside the locker 101, to sense optical data of the inner space 105. The optical data may be sensed when the first light source LS_1 is on and may be sensed when the first light source LS_1 is off. In one embodiment, the optical sensor OS is an image sensor thus the optical data is at least one image. The processing circuit 103 is configured to determine a light source condition of the first light source LS_1 or a locker condition of the locker 101 according to the optical data.

In the embodiment of FIG. 1A, the locker 101 further comprises a bottom surface 111. The side surface 107 is connected with the top surface 109 and the bottom surface 111. Also, a light blocking structure 113 is provided on the side surface 107 and between the first light source LS_1 and the optical sensor OS, to prevent the optical sensor OS from being interfered by the first light emitted from the first light source LS_1.

The first light source LS_1, the optical sensor OS and the light blocking structure 113 may be provided in the locker 101 corresponding to different requirements. In one embodiment, the first light source LS_1 and the optical sensor OS are respectively provided at different locations of the locker 101. In such case, the light blocking structure 113 may be provided close to a side of the optical sensor OS which is closer to the light source LS than another side, and the light blocking structure 113 may be substantially perpendicular with the side surface 107, as shown in FIG. 1A and FIG. 1B. FIG. 1B is a schematic diagram illustrating a combination module, according to one embodiment of the present invention, and is a schematic diagram of FIG. 1A viewed from the X direction.

In one embodiment, the first light source LS_1, the optical sensor OS and the light blocking structure 113 can be integrated to a combination module CM. As shown in FIG. 1B, the first light source LS_1, the optical sensor OS and the light blocking structure 113 are provided in or on the combination module CM. The combination module CM can be any shape rather than limited to the shape shown in FIG. 1B. Further, the combination module CM can be any carrier such as a box or a circuit board.

FIG. 1C is a schematic diagram illustrating a location of the combination module, according to one embodiment of the present invention. As shown in FIG. 1C, the combination module CM is mounted between side surfaces 106 and 107. However, the combination module CM may be mounted on only one side surface rather than limited to be between two side surfaces.

In one embodiment, a mounting angle in a range of 0°-45° may exist between the combination module CM and the side surface 107. For more detail, the side surface 107 is perpendicular with a bottom surface 108 of the locker 101. The mounting angle may be regarded as a tilt angle of the combination module CM. As shown in FIG. 1D, a mounting angle 115 in a range of 0°-45° exists between the combination module CM and the side surface 107. The mounting angle 115 is the same as an angle between a sensing direction SD of the optical sensor OS and a bottom surface 108 of the locker 101. The sensing direction SD is perpendicular with a sensing surface of the optical sensor OS, which can receive light. Please note, the mounting angle 115 may be any other angle smaller than 90°, rather than limited to be between 0°-45°.

The mounting angle 115 may be related with a height of the locker 101 and/or the installation height of the combination module CM. For example, if the height of the locker 101 is higher and the installation height of the combination module CM is higher, the mounting angle 115 needs to be larger such that the optical sensor OS can sense a larger inside region of the locker 101.

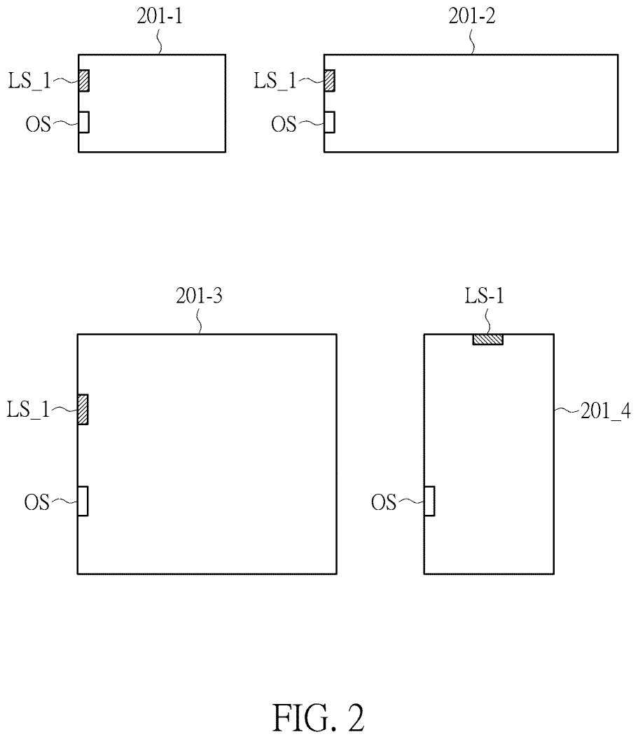

The above-mentioned locker condition may be a size of the locker. FIG. 2 is a schematic diagram illustrating lockers of different sizes according to embodiments of the present invention. Please note, the processing circuit 103 in FIG. 1A is not shown in the embodiment of FIG. 2. As shown in FIG. 2, the lockers 201_1, 201_2, 201_3 and 201_4 have different sizes. However, each of the lockers 201_1, 201_2, 201_3 and 201_4 comprise the first light source LS_1 and the optical sensor OS illustrated in FIG. 1A. As above-mentioned, the location of the first light source LS_1 may be changed to any required location. For example, the location of the first light source LS_1 in the locker 201_4 is different from locations of the first light sources LS_1 in the lockers 201_1, 201_2, 201_3, since the locker 201_4 has a straight long shape but the lockers 201_1, 201_2, 201_3 have horizontal long shapes. In the embodiment of FIG. 2, the processing circuit 103 can determine sizes of the lockers 201_1, 201_2, 201_3, 201_4 according to optical data sensed by the optical sensor OS. Detail steps of determining shapes of the lockers 201_1, 201_2, 201_3, 201_4 will be described for more detail in following descriptions.

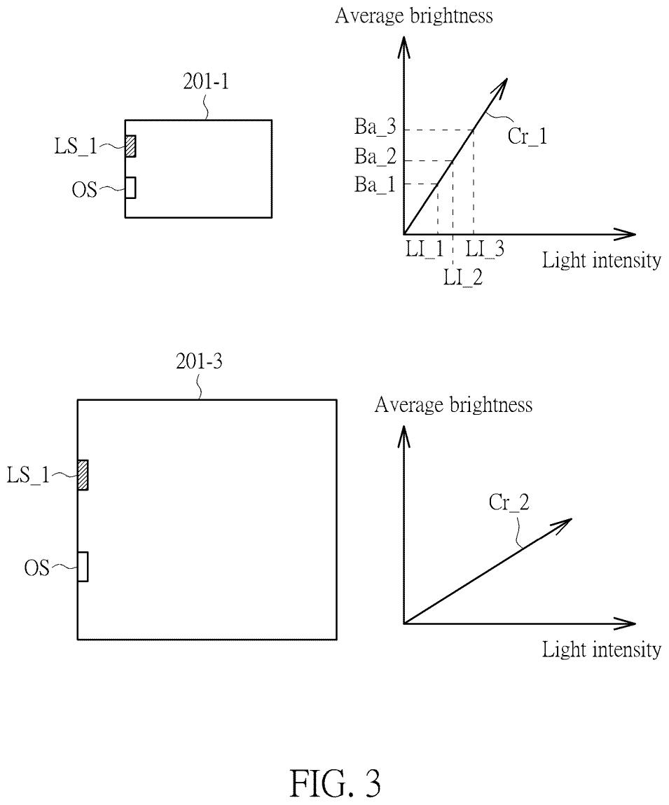

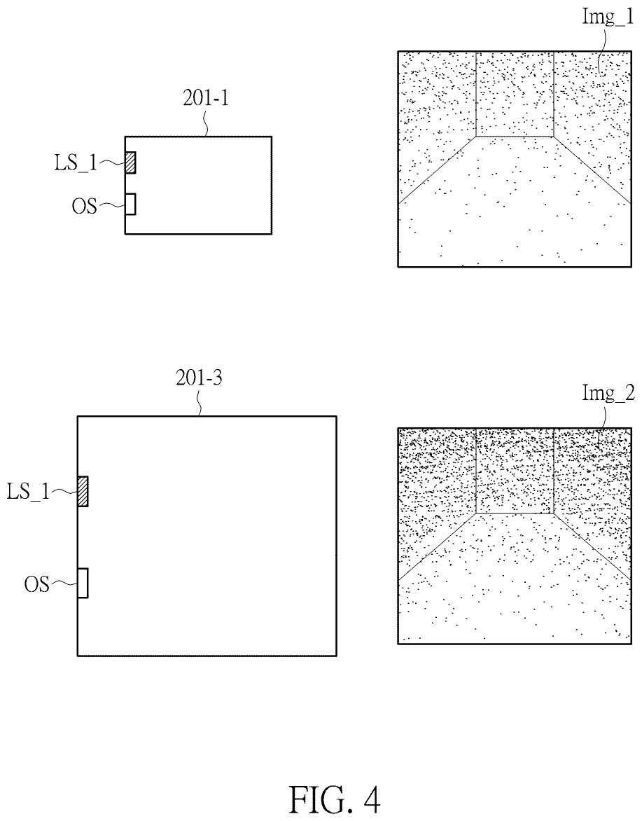

FIG. 3 and FIG. 4 are schematic diagrams illustrating examples of determining lockers of different sizes, according to embodiments of the present invention. In the embodiments of FIG. 3 and FIG. 4, only the lockers 201_1, 201_3 in FIG. 2 are used as examples for explaining. However, the concepts disclosed in FIG. 3 and FIG. 4 may be applied to lockers with other sizes.

In the embodiment of FIG. 3, the first light source L_1 emits first light with a plurality of light intensities. For example, the first light source L_1 emits first light with light intensities LI_1, LI_2 and LI_3. In such case, the optical sensor OS senses a plurality of sensing images corresponding to the light intensities. Also, the processing circuit 103 determines the size according to relations between the light intensities and brightness information of the sensing images. For example, for the locker 201_1 in FIG. 3, the sensing image has an average brightness Ba_1 if the first light has a light intensity LI_1, the sensing image has an average brightness Ba_2 if the first light has a light intensity LI_2 . . . and so on. Accordingly, a relation curve Cr_1 which represents relations between the light intensities and brightness information of the sensing images of the locker 201_1 can be acquired. It will be appreciated that the brightness information is not limited to the average brightness, for example, the brightness information may be a maximum brightness or a minimum brightness or a sum of the brightness.

Following the same rule, the relation curve Cr_2 of the locker 201_3 can be acquired. Since the lockers 201_1 and 201_3 have different sizes, the sensing images using the same light intensities may have different brightness information. Accordingly, the relation curves Cr_1 and Cr_2 have different distributions (e.g., different slops). Following such rule, the lockers of different sizes may have different relation curves.

Therefore, as long as the relation curves of all lockers of different sizes are measured and recorded in advance, and then the current relation curve of a target locker is obtained, the processing circuit 103 can compare the current relation curve with the recorded relation curves to determine the size of the target locker.

Specifically, if the target relation curve of the target locker is less different from a specific relation curve, the size of the target locker is closer to the size of the locker corresponding to the specific relation curve. The curve difference here may mean the difference in average brightness under the same light intensity. For example, if there are two lockers A and B and their relation curves are Cr_A and Cr_B. When the light intensities are LI_a, LI_b, LI_c respectively, the average brightness corresponding to the relation curve Cr_A is Ba_Aa, Ba_Ab, Ba_Ac respectively, and the average brightness corresponding to the relation curve Cr_B is Ba_Ba, Ba_Bb, Ba_Bc respectively, and the average brightness corresponding to the target relation curve is Ba_Ta, Ba_Tb, Ba_Tc respectively. In this case, if the differences between Ba_Ta, Ba_Tb, Ba_Tc and Ba_Aa, Ba_Ab, Ba_Ac are smaller than the differences between Ba_Ta, Ba_Tb, Ba_Tc and Ba_Ba, Ba_Bb, Ba_Bc, the size of the target locker is determined to be the size of locker A.

After obtaining the size of the target locker, the processing circuit 103 can automatically set the parameters of the first light source LS_1 (e.g., driving current) or the optical sensor OS (e.g., exposure time or frame rate) according to the size without manually adjusting them one by one as stated in the prior art.

The sizes of the lockers may be determined by other methods rather than limited to the method illustrated in FIG. 2. In the embodiment of FIG. 4, the first light source LS_1 in the locker 201_1 and the locker 201_3 respectively emits first light with a specific light intensity, and then the optical sensor senses a sensing image corresponding to the specific light intensity. The sensing images may have different brightness distributions if the lockers have different sizes, such as the sensing image Img_1 and the sensing image Img_2 in FIG. 4.

Therefore, as long as the sensing images of all lockers of different sizes are sensed using the first light with the specific light intensity and recorded in advance, and then a current sensing image of a target locker is obtained, the processing circuit 103 can compare brightness distributions of the current sensing image with brightness distributions of the recorded sensing images to determine the size of the target locker. After obtaining the size of the target locker, the processing circuit 103 can automatically set the parameters of the first light source LS_1 (e.g., driving current) or the optical sensor OS (e.g., exposure time or frame rate) according to the size without manually adjusting them one by one as stated in the prior art.

Besides the sizes of the lockers, different materials of the lockers may also cause different relations curves stated in FIG. 3 or different brightness distributions stated in FIG. 4, since different materials may have different light absorption rates or light reflection rates. Accordingly, the embodiments stated in FIG. 3 and FIG. 4 can also be used to determine the materials of lockers. Please note, the materials mentioned here may mean the materials that the locker is made of or the materials that is coated on the inner surface of the locker.

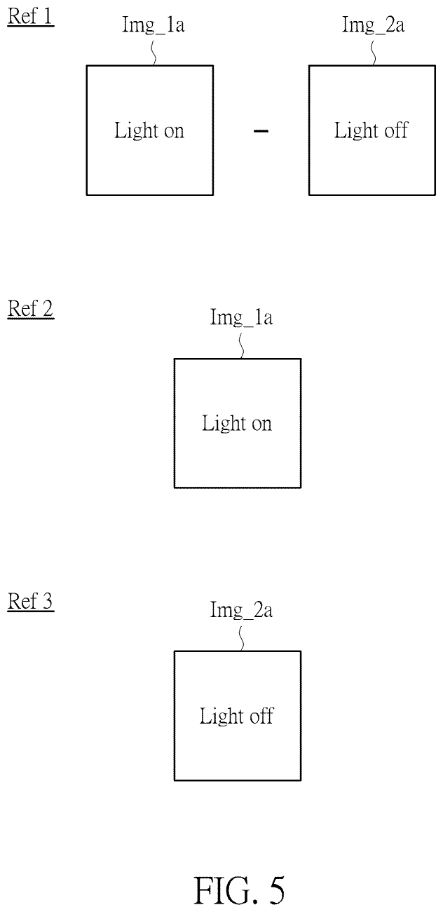

Besides the embodiments illustrated in FIG. 3 and FIG. 4, the light source condition or the locker condition may also be determined by other methods. FIG. 5 is a schematic diagram illustrating examples of determining the light source condition or the locker condition, according to embodiments of the present invention. In such case, the light source condition may mean light source aging and the locker condition may mean light leakage, but not limited.

In the embodiment of FIG. 5, the optical sensor OS senses first optical data (e.g., first image Img_1a) when the first light source LS_1 emits first light, and the optical sensor senses second optical data (e.g., second image Img_2a) when no light source in the locker emits light and a door of the locker 101 is closed. In such case, the processing circuit 103 determines a current light source condition or a current locker condition according to the first optical data minus the second optical data. Please note, the first optical data and the second optical mentioned here may be sensed under a circumstance ensuring that both the locker and the light source are intact.

For more detail, the result of the first optical data minus the second optical data may be recorded as reference optical data Ref 1. While determining a current light source condition or a current locker condition, current first optical data can be sensed when the first light source LS_1 emits the first light and current first optical data can be sensed when no light source in the locker emit light. Next, a current minus result of current first optical data minus current second optical data can be acquired.

Then, the processing circuit 103 determines the current light source condition or the current locker condition by comparing the current minus result with the Ref 1. For example, if a large difference between the current minus result and the reference optical data Ref 1 exists, it may mean the light intensity of the first light has an undesired change (e.g., due to the aging of the first light source LS_1) or the locker has light leakage. In such case, the parameters of the first light source LS_1 or the optical sensor OS may be calibrated, to try to reduce the interference caused by the undesired change of the light or the light leakage of the locker. Alternatively, the processing circuit 103 may generate an error message to inform that the locker needs to be inspected and fixed.

In one embodiment, if the difference is large, the parameters of the first light source LS_1 (e.g., a driving current) may be first automatically adjusted to check if the difference between the current minus result and the reference optical data Ref 1 can be reduced to an acceptable range. If the difference could not be adjusted to an acceptable range or the parameter variation of the first light source LS_1 is over an acceptable variation, it may mean the difference is not caused by light source aging but caused by light leakage of the locker, thus the processing circuit 103 may generate an error message to inform that the locker needs to be inspected and fixed.

Besides the minus result of the first optical data and the second optical data, the first optical data or the second optical data itself may be used to determine the light source condition. As shown in FIG. 5, the first optical data may be recorded as reference optical data Ref 2. While checking a current light source condition or a current locker condition, current first optical data can be sensed when the first light source LS_1 emits the first light. Then, the processing circuit 103 determines the current light source condition or the current locker condition by comparing the current first optical data with the reference optical data Ref 2.

For example, if a large difference between the current first optical data and the Ref 2 exists, it may mean the light intensity of the first light has an undesired change or the locker has light leakage. In such case, the parameters of the first light source LS_1 or the optical sensor OS may be adjusted, to try to reduce the difference between the current first optical data and the Ref 2. Alternatively, the processing circuit 103 may generate an error message to inform that the locker needs to be fixed.

Following the same rule, the second optical data may be recorded as reference optical data Ref 3. While checking a current light source condition or a current locker condition, current second optical data can be sensed when no light source in the locker emits light. Then, the processing circuit 103 determines the current light source condition or the current locker condition by comparing the current second optical data with the reference optical data Ref 3.

For example, if a large difference between the current second optical data and the reference optical data Ref 3 exists, it may mean the locker has light leakage. In such case, the parameters of the first light source LS_1 or the optical sensor OS may be adjusted, to try to reduce the interference caused by the light leakage. Alternatively, the processing circuit 103 may generate an error message to inform that the locker needs to be inspected and fixed.

As above-mentioned, if a non-ideal light source condition or a non-ideal locker condition is determined (i.e., difference exists between the reference optical data and current optical data), the processing circuit 103 may automatically adjust the parameters of the first light source LS_1 or the optical sensor OS. In one embodiment, the optical sensor OS senses first optical data when the first light source LS_1 emits first light, wherein the processing circuit 103 gradually adjusts a driving current of the first light source LS_1 according to brightness information of the first optical data, to adjust the brightness information (e.g., an average brightness) to predetermined brightness information. In other words, the processing circuit 103 calibrates the light intensity of the first light emitted from the first light source LS_1, thereby the brightness information of the first optical data can be adjusted to an ideal condition. By this way, the interference caused by the non-ideal light source condition or the non-ideal locker condition can be reduced. The ideal condition may mean, for example, the relation curve shown in FIG. 3 or the brightness distribution falls in an acceptable range.

As above-mentioned, the optical data of the inner space of the locker may be used to determine whether an object is put into the locker or not. In such case, the inner space of the locker may have some background regions which will not be affected by the placement or removal of objects. In other words, while determining the existence of the object, the optical data of the background region is not needed to be referred. Such background regions may be updated to increase the efficiency of determining objects.

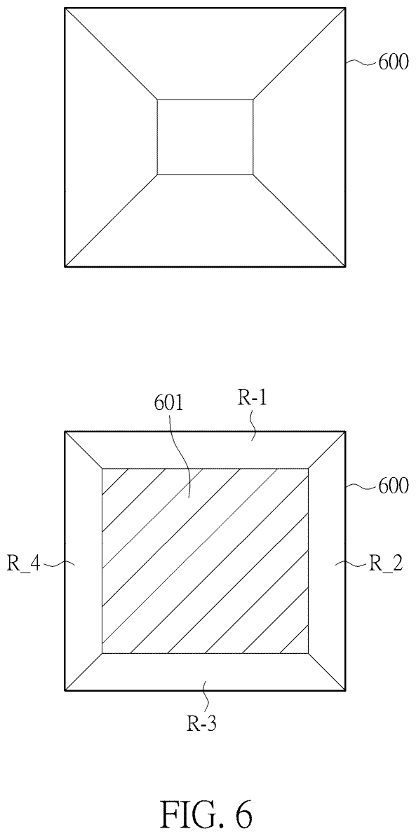

FIG. 6 is a schematic diagram illustrating an example of determining a background region, according to embodiments of the present invention. In the upper diagram of FIG. 6, no object is in the locker 600, thus the locker 600 is empty. In the lower diagram, the largest object 601 which the locker 600 can hold is placed in the locker 600. However, even in this case, the inner regions R_1, R_2, R_3, and R_4 of the locker 600 are still not covered by the object 601. Therefore, after the optical sensor OS senses the image corresponding to the upper diagram and the image corresponding to the lower diagram, the processing circuit 103 defines the inner regions R_1, R_2, R_3, and R_4 as background regions according to the two images.

The embodiment illustrated in FIG. 6 may be summarized as: the optical sensor OS senses third optical data when no object is inside the locker (e.g., the optical data of the upper diagram in FIG. 6), and the optical sensor senses fourth optical data when an object is inside the locker (e.g., the optical data of the lower diagram in FIG. 6). The processing circuit determines a background region according to a difference between the third optical data and the fourth optical data.

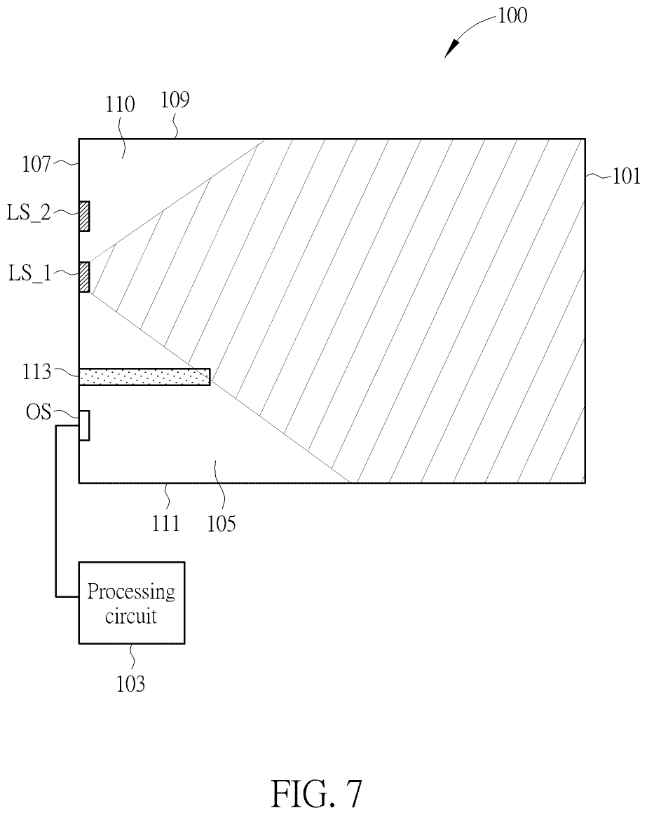

Sometimes, the object may have camouflage. For example, the object has a color similar with the color of interior surfaces of the locker. In such case, the determination of the object may be interfered by the camouflage. Accordingly, in following embodiment, a mechanism is provided to improve such issue. FIG. 7 is a schematic diagram illustrating avoiding camouflage of an object, according to embodiments of the present invention. In FIG. 7, besides the components shown in FIG. 1A, the locker 101 further comprises a second light source LS_2. The second light source LS_2 is provided inside the locker 101, configured to emit second light, wherein the first light and the second light has different light wavelengths.

The processing circuit 103 determines if there is an object in the locker according to optical data generated according to the first light and optical data generated according to the second light. The first light and the second light may be emitted simultaneously or alternatively. Since the object may have different responses to light with different light wave lengths, the structure of the locker 100 in FIG. 7 may improve the camouflage issue.

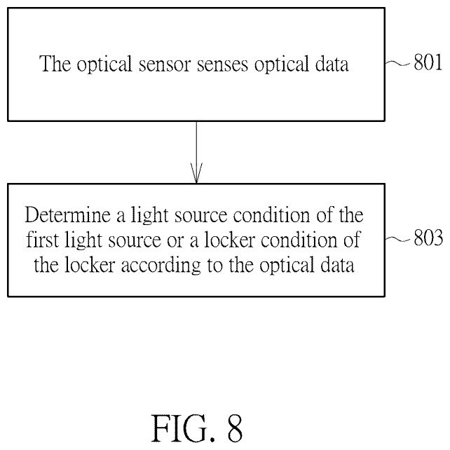

In view of above-mentioned embodiments, a locker management method can be acquired. FIG. 8 is a schematic diagram illustrating a locker management method, according to one embodiment of the present invention. The locker management method is applied to a locker (e.g., the locker 101 in FIG. 1A) comprising a first light source and an optical sensor provided therein, and comprises following steps:

### Step 801

The optical sensor senses optical data.

### Step 803

Determine a light source condition of the first light source or a locker condition of the locker according to the optical data.

As stated in the above-mentioned embodiments, the light source condition may be, for example, whether the first light source emits first light with a supposed light intensity or not. Also, the locker condition may be, for example, the size, the materials of the locker, or the locker has light leakage or not.

In view of above-mentioned embodiments, the light source condition and the locker condition may be automatically checked according to the optical data sensed by the optical sensor in the locker, rather than manually checked one by one. Besides, the parameters of the components in the locker can be automatically set according to the optical data sensed by the optical sensor in the locker, rather than manually checked one by one.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A locker system, comprising:
a locker;
a first light source, located inside the locker;
an optical sensor, located inside the locker, configured to sense optical data; and
a processing circuit, configured to determine a light source condition of the first light source or a locker condition of the locker according to the optical data.

2. The locker system of claim 1, wherein the locker comprises a top surface, a bottom surface and a side surface connected with the top surface and the bottom surface, wherein the first light source and the optical sensor are located on the side surface and a light blocking structure is provided on the side surface and between the first light source and the optical sensor.

3. The locker system of claim 1, wherein the processing circuit determines a size or a material of the locker according to the optical data.

4. The locker system of claim 3, wherein the first light source emits first light with a plurality of light intensities, wherein the optical sensor senses a plurality of sensing images corresponding to the light intensities, wherein the processing circuit determines the size or the material according to relations between the light intensities and brightness information of the sensing images.

5. The locker system of claim 3, wherein the first light source emits the first light with a specific light intensity, wherein the optical sensor senses a sensing image corresponding to the specific light intensity, wherein the processing circuit determines the size or the material according to brightness distribution of the sensing image.

6. The locker system of claim 1, wherein the optical sensor senses first optical data when the first light source emits first light, and the optical sensor senses second optical data when no light source in the locker emits light, wherein the processing circuit determines the light source condition or the locker condition according to one of the first optical data and the second optical data.

7. The locker system of claim 1, wherein the optical sensor senses first optical data when the first light source emits first light, and the optical sensor senses second optical data when no light source in the locker emits light, wherein the processing circuit determines the light source condition or the locker condition according to the first optical data minus the second optical data.

8. The locker system of claim 1, wherein the optical sensor senses first optical data when the first light source emits first light, wherein the processing circuit gradually adjusts a driving current of the first light source according to brightness information of the first optical data, to adjust the brightness information to predetermined brightness information.

9. The locker system of claim 1, wherein the optical sensor senses third optical data when no object is inside the locker, and the optical sensor senses fourth optical data when an object is inside the locker, wherein the processing circuit determines a background region according to a difference between the third optical data and the fourth optical data.

10. The locker system of claim 1, further comprising:
a second light source, provided inside the locker, configured to emit second light, wherein the first light and the second light has different light wavelengths;
wherein the processing circuit determines if there is an object in the locker according to optical data generated according to the first light and optical data generated according to the second light.

11. A locker management method, applied to a locker comprising a first light source and an optical sensor provided therein, comprising:
(a) the optical sensor sensing optical data; and
(b) determining a light source condition of the first light source or a locker condition of the locker according to the optical data.

12. The locker management method of claim 11, wherein the step (b) determines a size or a material of the locker according to the optical data.

13. The locker management method of claim 12, further comprising:
the first light source emitting first light with a plurality of light intensities;
the optical sensor sensing a plurality of sensing images corresponding to the light intensities;
wherein the step (b) determines the size or the type according to relations between the light intensities and brightness information of the sensing images.

14. The locker management method of claim 12, further comprising:
the first light source emitting the first light with a specific light intensity;
the optical sensor sensing a sensing image corresponding to the specific light intensity;
wherein the step (b) determines the size or the type according to brightness distribution of the sensing image.

15. The locker management method of claim 11, further comprising:
the optical sensor sensing first optical data when the first light source emits first light;
the optical sensor sensing second optical data when no light source in the locker emits light;
wherein the step (b) determines the light source condition or the locker condition according to one of the first optical data and the second optical data.

16. The locker management method of claim 11, further comprising:
the optical sensor sensing first optical data when the first light source emits first light;
the optical sensor sensing second optical data when no light source in the locker emits light;
wherein the step (b) determines the light source condition or the locker condition according to the first optical data minus the second optical data.

17. The locker management method of claim 11, further comprising:
the optical sensor sensing first optical data when the first light source emits first light;
wherein the step (b) adjusts a driving current of the first light source according to brightness information of the first optical data.

18. The locker management method of claim 11, further comprising:
the optical sensor sensing third optical data when no object is inside the locker;
the optical sensor sensing fourth optical data when an object is inside the locker;
wherein the step (b) determines a background region according to a difference between the third optical data and the fourth optical data.

19. The locker management method of claim 11,
wherein the locker further comprises a second light source provided therein, the second light source is configured to emit second light, wherein the first light and the second light has different light wavelengths;
wherein the step (b) determines if there is an object in the locker according to optical data generated according to the first light and optical data generated according to the second light.
